(19) United States
(12) Patent Application Publication
(10) Pub. No.: US 2025/0123545 A1
(43) Pub. Date: Apr. 17, 2025

(54) Projector Protection Case

(71) Applicant: Alexander B. Patterson, Brooklyn, NY (US)

(72) Inventor: Alexander B. Patterson, Brooklyn, NY (US)

(21) Appl. No.: 18/913,884

(22) Filed: Oct. 11, 2024

Related U.S. Application Data
(60) Provisional application No. 63/590,357, filed on Oct. 13, 2023.

(51) Int. Cl. G03B 21/16; G03B 21/14

(52) U.S. Cl. CPC G03B 21/16; G03B 21/145

(57) ABSTRACT

The present invention relates to a projector protection case designed to enclose a display projector. The case comprises a plurality of solid sides and airtight seals between each of the solid sides, ensuring a secure and protective enclosure. The case further includes an air intake opening to facilitate proper ventilation. Additionally, a projector lens opening is provided, configured with a deliberate gap between the lens and the case to prevent the maintenance of an airtight seal. This intentional design feature allows for the efficient dissipation of heat generated by the projector, ensuring optimal performance and longevity. The projector protection case provides a reliable and durable solution for safeguarding display projectors while maintaining proper ventilation for optimal functionality.

### PRIORITY

This application claims the benefit of and priority to U.S. Provisional Application, entitled “Projector Protection Case”, filed on Oct. 13, 2023 and having application Ser. No. 63/590,357, the entirety of said application being incorporated herein by reference.

### FIELD

The present disclosure relates to interactive gaming. More particularly, the present disclosure relates to configuring a four-walled game room with a plurality of games that utilize a series of gaming components.

The present disclosure relates to interactive gaming. More particularly, the present disclosure relates to a protective case for a projector exposed to fog during an interactive game.

### BACKGROUND

Previous approaches for protecting display projectors have involved the use of various types of cases or enclosures. These cases are designed to provide physical protection to the projector and prevent damage from external factors such as dust, moisture, and impact. However, these cases have not adequately addressed the issue of heat dissipation, which is crucial for the proper functioning and longevity of the projector.

One common approach has been to use cases with solid sides and airtight seals between each of the sides. While this design provides excellent protection against dust and moisture, it also restricts airflow and hampers heat dissipation. As a result, the projector may overheat, leading to reduced performance, increased wear and tear, and potential damage to internal components.

Another approach has been to incorporate ventilation systems into the cases to facilitate airflow and heat dissipation. These ventilation systems typically include air intake openings and exhaust vents. However, these systems often compromise the protective qualities of the case by allowing dust and moisture to enter through the openings. Additionally, the ventilation systems may not be effective in maintaining a consistent and optimal temperature within the case, especially in environments with high ambient temperatures or limited airflow.

Furthermore, some cases have attempted to address the issue of heat dissipation by incorporating openings around the projector lens. However, these openings are often designed to maintain an airtight seal, which restricts airflow and hampers heat dissipation. Consequently, the projector may still be prone to overheating and associated performance issues.

In summary, previous approaches to projector protection cases have focused on providing physical protection but have not adequately addressed the issue of heat dissipation. These approaches either restrict airflow and hinder heat dissipation or compromise the protective qualities of the case. However, none of these approaches have provided a comprehensive solution that combines the features described in this disclosure.

### SUMMARY OF THE DISCLOSURE

Systems and methods for a protective case for a projector exposed to fog during an interactive game in accordance with embodiments of the disclosure are described herein.

In some embodiments, a projector protection case includes a case suitable for enclosing around a display projector wherein the case includes: a plurality of solid sides; airtight seals between each of the solid sides; an air intake opening; a projector lens opening, wherein the opening is configured with a gap between the lens and the case such that an airtight seal is not maintained.

In some embodiments, the gap between the lens and the case is configured to allow air escape in a pathway along the length of the lens.

In some embodiments, the air intake is configured with an air vent configured to provide air at a first air pressure.

In some embodiments, the first air pressure is sufficient to maintain a constant amount of air to escape the pathway along the length of the lens.

In some embodiments, constant amount of air is sufficient to keep fog particulates from amassing on the lens.

In some embodiments, the projector case is further included with a plurality of model-specific openings.

In some embodiments, the model-specific openings are configured to allow for the coupling between the case and one or more protrusions of a particular model of projector.

In some embodiments, the coupling between the model-specific openings of the case and the one or more protrusions of the particular model of projector provide a near airtight seal.

In some embodiments, the coupling between the model-specific openings of the case and the one or more protrusions of the particular model of projector provide an airtight seal.

In some embodiments, the projector case is further included with a plurality of temperature regulating vent holes.

In some embodiments, the temperature regulating vent holes are configured over an area known to experience high temperatures during usage.

In some embodiments, the temperature regulating vent holes are covered in a material.

In some embodiments, a method of protecting a projector from fog, wherein the method includes: enclosing the projector within a case, wherein the case includes: a plurality of solid sides; airtight seals between each of the solid sides; an air intake opening; and a projector lens opening, wherein the opening is configured with a gap between the lens and the case such that an airtight seal is not maintained; and mounting the projector in the case; providing the air intake opening with a supply of clean air.

In some embodiments, the gap between the lens and the case is configured to allow air escape in a pathway along the length of the lens.

In some embodiments, the air intake is configured with an air vent configured to provide air at a first air pressure.

In some embodiments, the first air pressure is sufficient to maintain a constant amount of air to escape the pathway along the length of the lens.

In some embodiments constant amount of air is sufficient to keep fog particulates from amassing on the lens.

In some embodiments, the projector case is further included with a plurality of model-specific openings.

In some embodiments, the model-specific openings are configured to allow for the coupling between the case and one or more protrusions of a particular model of projector.

In some embodiments, the coupling between the model-specific openings of the case and the one or more protrusions of the particular model of projector provide a near airtight seal.

In some embodiments, the coupling between the model-specific openings of the case and the one or more protrusions of the particular model of projector provide an airtight seal.

In some embodiments, the projector case is further included with a plurality of temperature regulating vent holes.

In some embodiments, the temperature regulating vent holes are configured over an area known to experience high temperatures during usage.

In some embodiments, the temperature regulating vent holes are covered in a material.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a photo of a projector inside of a projector protector case in accordance with various embodiments of the disclosure; and

FIG. 2 is an underside view of the projector protection case with a plurality of model-specific openings in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that protects a projector by utilizing an airtight case for temperature regulation and fog avoidance while creating a desired air loss such that a stream of air is directed over the lens to keep fog particles from amassing on the lens over time.

Fog emitting from an interactive laser maze game are known to destroy many a projector, getting into the working mechanisms, fogging up the lenses, etc. To unfog you had to take apart the projector and clean the lens. This can be a very time-consuming process and putting it back together was difficult. Also, fog is hot and could cause the projector to overheat. Various embodiments described herein are configured to generate a positive pressure of clean air circulating into the case and out past the lens and other mechanisms, keeping fog or other smoke or air contaminants from entering the projector itself (which has its own case but not that that case is airtight).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

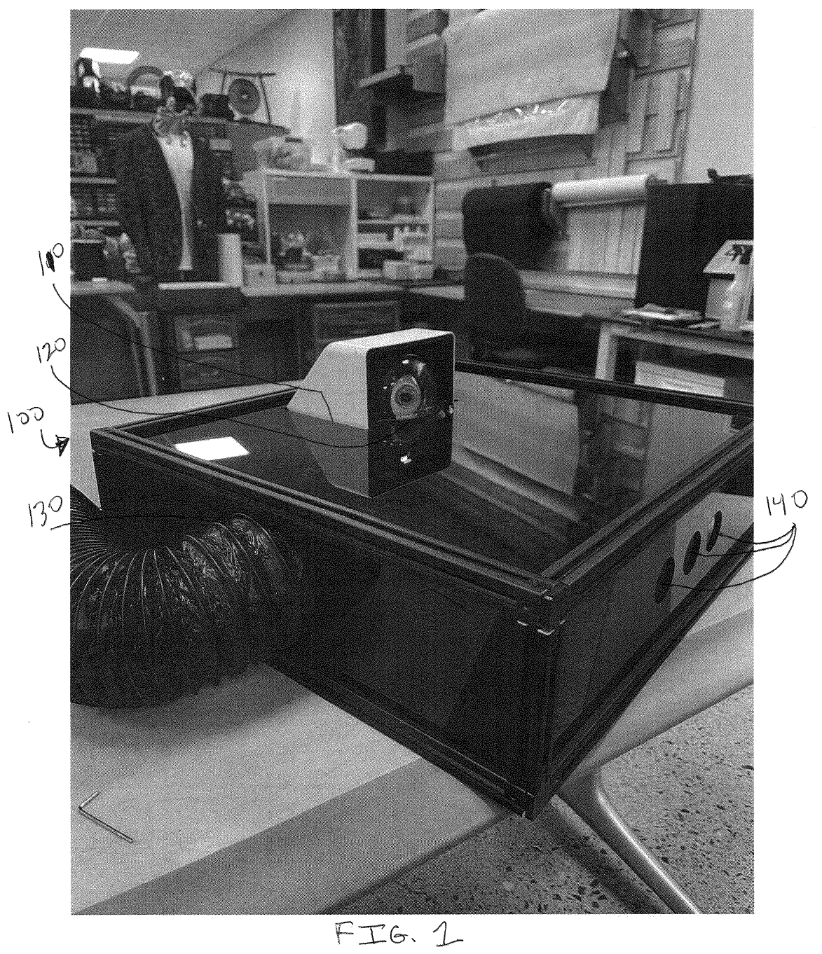

Referring to FIG. 1, a photo of a projector inside of a projector protector case 100 in accordance with various embodiments of the disclosure is shown. In many embodiments, the projector protector case 100 will have a plurality of solid sides, with at least some of these sides having an airtight or near airtight seal comprising them both. In certain embodiments, the projector protector case 100 may have a solid metal frame that the solid sides are configured to work into.

In more embodiments, the projector protector case 100 can have an air intake opening 130 that is configured to allow air to enter the projector protector case 100, often under pressure. In the embodiment depicted in FIG. 1, the air intake opening 130 is connected to a tubing that provides a positive air pressure to the inside of the projector protector case 100. This positive pressure can be released through a variety of vent holes 140 which can be configured as open holes or have material over them to slow the release of air from the projector protector case 100. In some embodiments, the vent holes 140 are positioned in strategic areas that may otherwise suffer from overheating, or block one or more sensors, etc.

The projector protector case 100 can be configured with a lens opening 110 that allows the lens or other display equipment to protrude from the projector protector case 100. In certain embodiments, the solid side associated with the projector lens is cut on a precisions machine to allow for the lens to be able to project an image outside of the projector protector case 100. However, in a number of embodiments, the projector protector case 100 can include a gap between the lens and the solid side, often with the gap being placed in front of the lens. As a result of this, a positive air pressure stream can be released over the lens such that fog or other dirt and/or particulates can amass or otherwise accumulate on the lens. Without this, the lifespan of the projector may be shortened, especially in rooms that utilize fog for various lengths of time. This can be especially relevant to interactive game rooms like laser mazes that require smoke in the room during most of the gameplay time to allow the players to see the laser beams across the room.

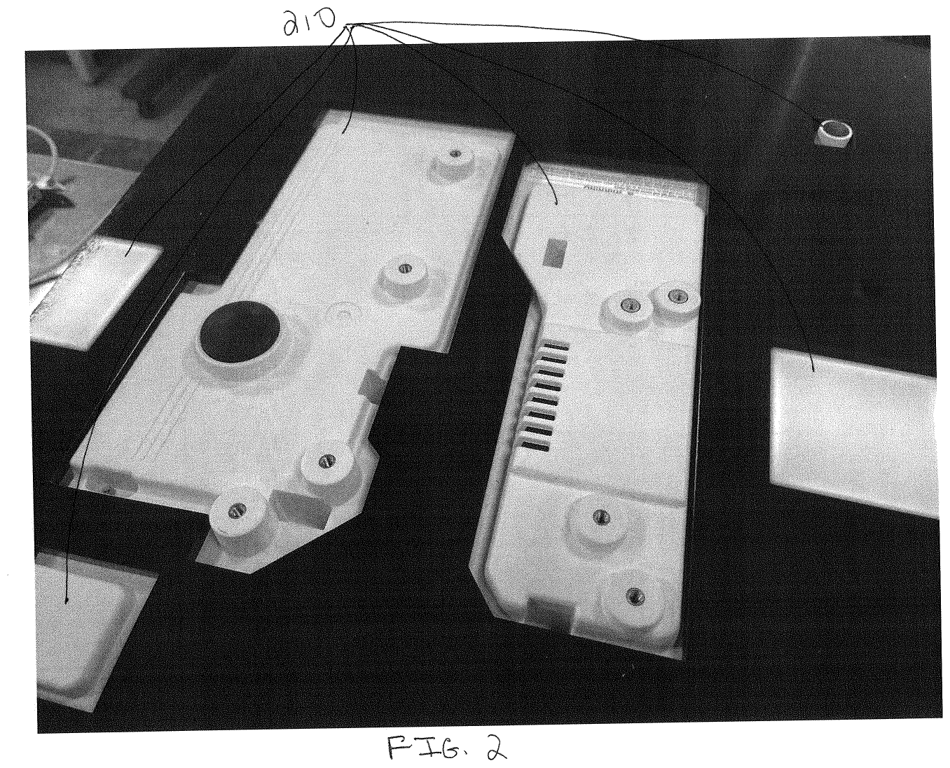

Although a specific embodiment for a projector inside of a projector protector case 100 suitable for carrying out the various steps, processes, methods, and operations described herein is discussed with respect to FIG. 1, any of a variety of systems and/or processes may be utilized in accordance with embodiments of the disclosure. For example, the lends may be in a different position requiring a different type of gap to be placed to allow a positive pressure airflow over the lens. The elements depicted in FIG. 1 may also be interchangeable with other elements of FIG. 2 as required to realize a particularly desired embodiment.

Referring to FIG. 2, an underside view of the projector protection case with a plurality of model-specific openings 210 in accordance with various embodiments of the disclosure is shown. As those skilled in the art will recognize, projectors can come in a variety of shapes and/or configurations. Thus, in order to allow for these different models, the projector protector case can be configured for each specific model type through the use of model-specific holes 210. In the embodiment depicted in FIG. 2, the plurality of model specific holes 210 allow for any protrusions to exit the projector protector case while the bulk of the unit stays inside. By utilizing these model-specific holes 210, the projector protector case can maintain an airtight or near airtight seal to create positive airflow over the lens without an increased need for air pressure from the air inlet.

Although a specific embodiment for an underside view of the projector protection case with a plurality of model-specific openings suitable for carrying out the various steps, processes, methods, and operations described herein is discussed with respect to FIG. 2, any of a variety of systems and/or processes may be utilized in accordance with embodiments of the disclosure. For example, the projector protector case can be 3D printed or cut on a laser cutting machine specific to the model required. The elements depicted in FIG. 2 may also be interchangeable with other elements of FIG. 1 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A projector protection case, comprising:
a case suitable for enclosing around a display projector wherein the case comprises:
a plurality of solid sides;
airtight seals between each of the solid sides;
an air intake opening;
a projector lens opening, wherein the opening is configured with a gap between the lens and the case such that an airtight seal is not maintained.

2. The projector protection case of claim 1, wherein the gap between the lens and the case is configured to allow air escape in a pathway along a length of the lens.

3. The projector protection case of claim 2, wherein the air intake is configured with an air vent configured to provide air at a first air pressure.

4. The projector protection case of claim 3, wherein the first air pressure is sufficient to maintain a constant amount of air to escape the pathway along the length of the lens.

5. The projector protection case of claim 4, wherein constant amount of air is sufficient to keep fog particulates from amassing on the lens.

6. The projector protection case of claim 1, wherein the projector case is further comprised with a plurality of model-specific openings.

7. The projector protection case of claim 6, wherein the model-specific openings are configured to allow for a coupling between the case and one or more protrusions of a particular model of projector.

8. The projector protection case of claim 7, wherein the coupling between the model-specific openings of the case and the one or more protrusions of the particular model of projector provide a near airtight seal.

9. The projector protection case of claim 7, wherein the coupling between the model-specific openings of the case and the one or more protrusions of the particular model of projector provide an airtight seal.

10. The projector protection case of claim 1, wherein the projector case is further comprised with a plurality of temperature regulating vent holes.

11. The projector protection case of claim 10, wherein the temperature regulating vent holes are configured over an area known to experience high temperatures during usage.

12. The projector protection case of claim 11, wherein the temperature regulating vent holes are covered in a material.

13. A method of protecting a projector from fog, wherein the method comprises:
enclosing the projector within a case, wherein the case comprises:
a plurality of solid sides;
airtight seals between each of the solid sides;
an air intake opening; and
a projector lens opening, wherein the opening is configured with a gap between the lens and the case such that an airtight seal is not maintained; and
mounting the projector in the case;
providing the air intake opening with a supply of clean air.

14. The method of claim 13, wherein the gap between the lens and the case is configured to allow air escape in a pathway along a length of the lens.

15. The method of claim 14, wherein the air intake is configured with an air vent configured to provide air at a first air pressure.

16. The method of claim 15, wherein the first air pressure is sufficient to maintain a constant amount of air to escape the pathway along the length of the lens.

17. The method of claim 16, wherein constant amount of air is sufficient to keep fog particulates from amassing on the lens.

18. The method of claim 13, wherein the projector case is further comprised with a plurality of model-specific openings.

19. The method of claim 18, wherein the model-specific openings are configured to allow for a coupling between the case and one or more protrusions of a particular model of projector.

20. The method of claim 19, wherein the coupling between the model-specific openings of the case and the one or more protrusions of the particular model of projector provide a near airtight seal.

21. The method of claim 19, wherein the coupling between the model-specific openings of the case and the one or more protrusions of the particular model of projector provide an airtight seal.

22. The method of claim 13, wherein the projector case is further comprised with a plurality of temperature regulating vent holes.

23. The method of claim 22, wherein the temperature regulating vent holes are configured over an area known to experience high temperatures during usage.

24. The method of claim 23, wherein the temperature regulating vent holes are covered in a material.
